(19) United States
(12) Patent Application Publication
(10) Pub. No.: US 2025/0214229 A1
(43) Pub. Date: Jul. 3, 2025

(54) SNAKE ARM ROBOT

(71) Applicant: GIST(Gwangju Institute of Science and Technology), Gwangju (KR)

(72) Inventors: Jung Won YOON, Gwangju (KR); Ho Young KIM, Gwangju (KR)

(73) Assignee: GIST(Gwangju Institute of Science and Technology), Gwangju (KR)

(21) Appl. No.: 19/009,229

(22) Filed: Jan. 3, 2025

(30) Foreign Application Priority Data
Jan. 3, 2024 (KR) 10-2024-0000973

(51) Int. Cl. B25J 9/06; B25J 9/10; B25J 17/00

(52) U.S. Cl. CPC B25J 9/065; B25J 9/104; B25J 9/1075; B25J 17/00

(57) ABSTRACT

The present disclosure relates to a snake arm robot, which includes: a base disk; a rotary unit rotatably connected to the base disk and having multiple sub-disks sequentially arranged in a predetermined arrangement direction and rotatably connected to each other; a wire connector having multiple wires connected to the base disk or a plurality of disks selected from the sub-disks and sequentially disposed in the arrangement direction or disposed to partially face each other in a circumferential direction of the sub-disks; and a wire operator operating the wires to rotate the sub-disks by a predetermined angle.

According to the snake arm robot of the present disclosure, since wires connected to disks to rotate the disks are arranged in a similar type to the muscle structure of a nematode, there is the advantage that rigidity and payload are increased.

### CROSS REFERENCE TO RELATED APPLICATION

The present application claims priority to Korean Patent Application No. 10-2024-0000973, filed Jan. 3, 2024, the entire contents of which are incorporated herein for all purposes by this reference.

### BACKGROUND

### Technical Field

The present disclosure relates to a snake arm robot and, in more detail, a snake arm robot in which wires connected to multiple disks are arranged similarly to the muscle structure of nematodes.

### Description of the Related Art

A robot arm is a kind of robots that are most generally used in the industry and the demand for robot arms is increasing with the continuous increase of the level and requirements of Since robots with high degree of freedom have the industry flexibility, the application ranges, work spaces, and remote processing abilities of such robots are greatly improved and the robots can inspect defects and have the ability to avoid obstacles in narrow and curved spaces, which is difficult to achieve in general robots.

Further, it is possible to enter insides through observation holes and perform work such as examining of the operation situation of machines or washing of critical parts, maintaining, sealing of the joints of curved pipes, inspecting, and minimal invasion without separating boxes when inspecting mechanical facilities. Snake-shaped multi-joint flexible robot arms generally work in conveying carts or automated lines and are equipped with various tools at the end, such as a camera, a searchlight, a cutter, and a brush, whereby these robots can perform seal testing and can perform safety inspection even in limited spaces in the cargo compartment of airplanes.

However, since wires for rotating disks are arranged simple in a line in multi-joint flexible robot arms and the wires are configured such that one end is fixed to a disk and the other end is wound on a winding drum, there is a limitation that the rigidity and the payload of the robots are relatively low.

### SUMMARY

The present disclosure has been made in an effort to solve the problems described above and an objective of the present disclosure is to provide a snake arm robot in which wires connected to disks are arranged similarly to the muscle structure of nematodes.

In order to achieve the objectives, a snake arm robot according to the present disclosure includes: a base disk; a rotary unit rotatably connected to the base disk and having multiple sub-disks sequentially arranged in a predetermined arrangement direction and rotatably connected to each other; a wire connector having multiple wires connected to the base disk or a plurality of disks selected from the sub-disks and sequentially disposed in the arrangement direction or disposed to partially face each other in a circumferential direction of the sub-disks; and a wire operator operating the wires to rotate the sub-disks by a predetermined angle.

The wires are radially disposed around a center of the base disk or the sub-disks.

The rotary unit includes multiple odd sub-disks and even sub-disks rotatably connected to each other by rotary joints, and the odd sub-disks and even sub-disks are alternately arranged in the arrangement direction; and the wires are connected to the odd sub-disks adjacent to each other or the even sub-disks adjacent to each other, respectively.

The wire connector includes: a first sub-connecting unit including multiple first sub-pulleys rotatably installed on any one of the odd sub-disks adjacent to each other, and multiple first sub-wires installed on the other one of the odd sub-disks adjacent to each other, wound on the first sub-pulleys, and having an end connected to the wire operator; and a second sub-connecting unit including multiple second sub-pulleys rotatably installed on any one of the even sub-disks adjacent to each other, and multiple second sub-wires installed on the other one of the even sub-disks adjacent to each other, wound on the second sub-pulleys, and having an end connected to the wire operator.

The first sub-wires are radially disposed around a center of the odd sub-disk, and the second sub-wires are radially disposed around a center of the even sub-disk and are disposed between the first sub-wires adjacent to each other.

The wire connector includes: a first main connecting unit including a first main pulley rotatably installed on an odd sub-disk that is the most adjacent to the base disk of the odd sub-disks, and multiple first main wires installed on the base disk, wound on the first main pulley, and having an end connected to the wire operator; and a second main connecting unit including a second main pulley rotatably installed on an even sub-disk that is the most adjacent to the base disk of the even sub-disks, and multiple second main wires installed on the base disk, wound on the second main pulley, and having an end connected to the wire operator.

It is preferable that the first main wires and the second main wires are radially disposed around the center of the base disk and are alternately arranged in a circumferential direction of the base disk.

A first sub-wire installed on the odd sub-disk that is the most adjacent to the base disk of the first sub-wires may be disposed between the second main wires.

A first sub-wire installed on the odd sub-disk that is the most adjacent to the base disk of the first sub-wires may be disposed to face the first main wire in the arrangement direction.

A second sub-wire installed on the even sub-disk that is the most adjacent to the base disk of the second sub-wires may be disposed to face the second main wire in the arrangement direction.

The wire operator includes a first main rotary unit pulling or releasing the first main wires facing each other with the center of the base disk therebetween.

First ends of the first main wires facing each other with the center of the base disk therebetween are installed on the base disk or the odd sub-disk, the frame has first wire fixing portions formed at positions spaced apart from each other such that second ends of the first main wires facing each other with the center of the base disk therebetween can be installed respectively thereto, and the first main rotary unit includes: a first moving block installed to be adjacent to any one of the first wire fixing portions on the frame between the first wire fixing portions and to be able to slide away from the other one of the first wire fixing portions; a plurality of first supporting rollers installed at the first moving block such that the first main wires facing each other with the center of the base disk therebetween are wound on outer circumferential surfaces thereof; multiple first guide rollers installed on the frame to guide the first main wires facing each other with the center of the base disk therebetween to be wound on the first supporting rollers, respectively; and a first block moving member moving the first moving block such that pulling force is applied to any one of the first main wires facing each other with the center of the base disk therebetween and pulling force is not applied to the other one of the first main wires.

The wire operator includes a second main rotary unit pulling or releasing the second main wires facing each other with the center of the base disk therebetween.

First ends of the second main wires facing each other with the center of the base disk therebetween are installed on the base disk or the even sub-disk, the frame has second wire fixing portions formed at positions spaced apart from each other such that second ends of the second main wires facing each other with the center of the base disk therebetween can be installed respectively thereto, and the second main rotary unit includes: a second moving block installed to be adjacent to any one of the second wire fixing portions on the frame between the second wire fixing portions and to be able to slide away from the other one of the second wire fixing portions; a plurality of second supporting rollers installed at the second moving block such that the second main wires facing each other with the center of the base disk therebetween are wound on outer circumferential surfaces thereof; multiple second guide rollers installed on the frame to guide the second main wires facing each other with the center of the base disk therebetween to be wound on the second supporting rollers, respectively; and a second block moving member moving the second moving block such that pulling force is applied to any one of the second main wires facing each other with the center of the base disk therebetween and pulling force is not applied to the other one of the second main wires.

The wire operator includes a first sub-rotary unit pulling or releasing the first sub-wires facing each other with the center of the base disk therebetween.

First ends of first sub-wires facing each other with the center of the base disk therebetween are installed on the odd sub-disk, the frame has third wire fixing portions formed at positions spaced apart from each other such that second ends of the first sub-wires facing each other with the center of the base disk therebetween can be installed respectively thereto, and the first sub-rotary unit includes: a third moving block installed to be adjacent to any one of the third wire fixing portions on the frame between the third wire fixing portions and to be able to slide away from the other one of the third wire fixing portions; a plurality of third supporting rollers installed at the third moving block such that the first sub-wires facing each other with the center of the base disk therebetween are wound on outer circumferential surfaces thereof; multiple third guide rollers installed on the frame to guide the first sub-wires facing each other with the center of the base disk therebetween to be wound on the third supporting rollers, respectively; and a third block moving member moving the third moving block such that pulling force is applied to any one of the first sub-wires facing each other with the center of the base disk therebetween and pulling force is not applied to the other one of the first sub-wires.

The wire operator may include a second sub-rotary unit pulling or releasing the second sub-wires facing each other with the center of the base disk therebetween.

First ends of the second sub-wires facing each other with the center of the base disk therebetween are installed on the even sub-disk, the frame has fourth wire fixing portions formed at positions spaced apart from each other such that second ends of the second sub-wires facing each other with the center of the base disk therebetween can be installed respectively thereto, and the second sub-rotary unit includes: a fourth moving block installed to be adjacent to any one of the fourth wire fixing portions on the frame between the fourth wire fixing portions and to be able to slide away from the other one of the fourth wire fixing portions; a plurality of fourth supporting rollers installed at the fourth moving block such that the second sub-wires facing each other with the center of the base disk therebetween are wound on outer circumferential surfaces thereof; multiple fourth guide rollers installed on the frame to guide the second sub-wires facing each other with the center of the base disk therebetween to be wound on the fourth supporting rollers, respectively; and a fourth block moving member moving the fourth moving block such that pulling force is applied to any one of the second sub-wires facing each other with the center of the base disk therebetween and pulling force is not applied to the other one of the second sub-wires.

It is preferable that the rotary joint is a quaternion joint.

According to the snake arm robot of the present disclosure, since wires connected to disks to rotate the disks are arranged in a similar type to the muscle structure of a nematode, there is the advantage that rigidity and payload are increased.

### BRIEF DESCRIPTION OF THE DRAWINGS

FIG. 1 is a perspective view of a snake arm robot according to an embodiment of the present disclosure;

FIG. 2 is a partial side view of the snake arm robot of FIG. 1;

FIG. 3 is a conceptual view of wire joints of the snake arm robot of FIG. 1;

FIG. 4 is a conceptual view of a wire operator of the snake arm robot of FIG. 1;

FIG. 5 is a front view of a base disk of the snake arm robot of FIG. 1;

FIG. 6 is a conceptual view of a first main connecting unit of the snake arm robot of FIG. 1;

FIG. 7 is a conceptual view of a first main connecting unit according to another embodiment of the present disclosure;

FIG. 8 is a conceptual view of a first main connecting unit according to another embodiment of the present disclosure;

FIG. 9 is an exemplary view of the muscle structure of a nematode;

FIG. 10 is a perspective view of an anti-wire interference unit of a snake arm robot according to an embodiment of the present disclosure; and

FIG. 11 is a picture showing a performance test of a snake arm robot according to the present disclosure.

### DETAILED DESCRIPTION

Hereafter, a stake arm robot according to an embodiment of the present disclosure is described in detail with reference to the accompanying drawings. The present disclosure may be modified in various ways and implemented by various exemplary embodiments, so specific exemplary embodiments are shown in the drawings and will be described in detail herein. However, it is to be understood that the present disclosure is not limited to the specific exemplary embodiments, but includes all modifications, equivalents, and substitutions included in the spirit and the scope of the present disclosure. Similar reference numerals are assigned to similar components in the following description of drawings. In the accompanying drawings, the dimensions of structures were exaggerated larger than the actual dimensions to make the present disclosure clear.

Terms used in the specification, “first”, “second”, etc., may be used to describe various components, but the components are not to be construed as being limited to the terms. The terms are used only to distinguish one component from another component. For example, the “first” component may be named the “second” component, and vice versa, without departing from the scope of the present disclosure.

The terms used herein are used only for the purpose of describing particular embodiments and are not intended to limit the present disclosure. Singular forms are intended to include plural forms unless the context clearly indicates otherwise. It will be further understood that the terms “comprises” or “have” used in this specification specify the presence of stated features, steps, operations, components, parts, or a combination thereof, but do not preclude the presence or addition of one or more other features, numerals, steps, operations, components, parts, or a combination thereof.

Unless defined otherwise, it is to be understood that all the terms used in the specification including technical and scientific terms have the same meanings as those that are understood by those who skilled in the art. It will be further understood that terms such as terms defined in common dictionaries should be interpreted as having a meaning that is consistent with their meaning in the context of this specification and the relevant art and will not be interpreted in an idealized or overly formal sense unless expressly so defined herein.

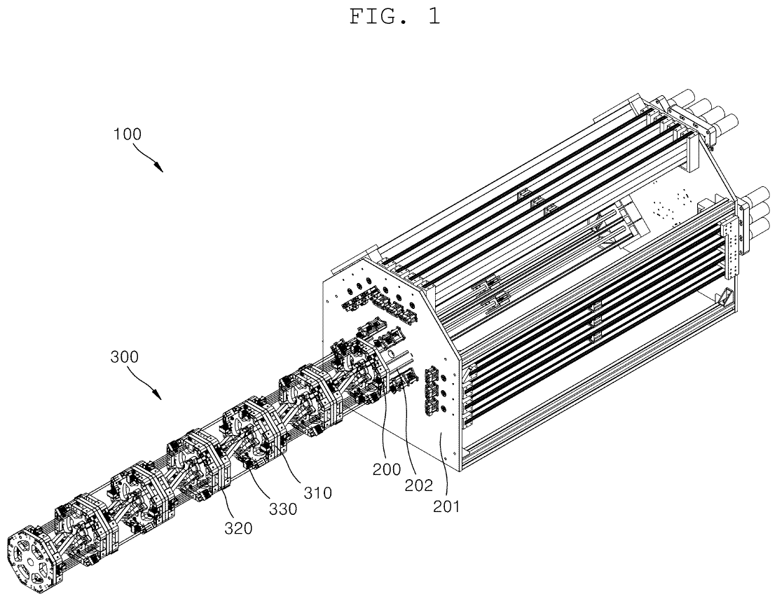

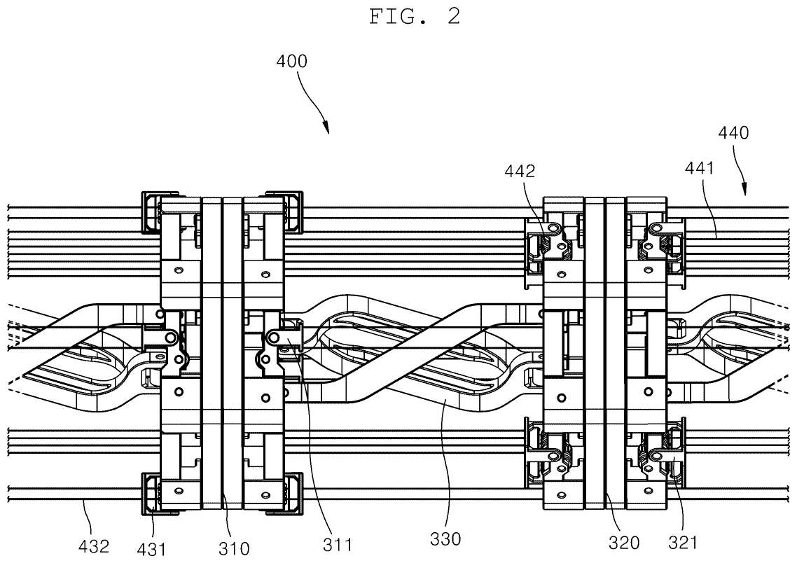

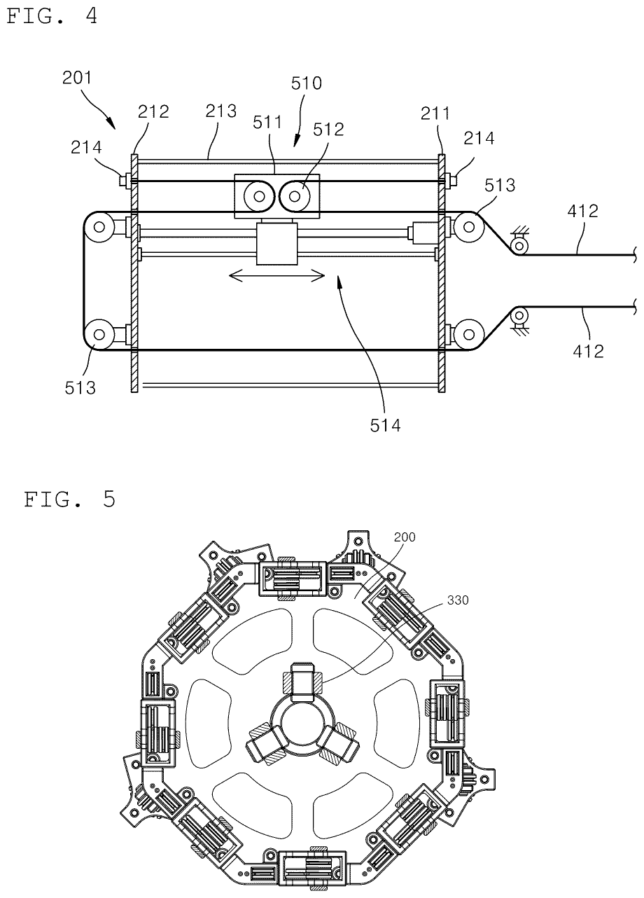

A snake arm robot 100 according to an embodiment of the present disclosure is shown in FIG. 1 to FIG. 6.

Referring to the figures, the snake arm robot 100 includes: a base disk 200; a rotary unit 300 rotatably connected to the base disk 200 and having multiple sub-disks sequentially arranged in a predetermined arrangement direction and rotatably connected to each other; a wire connector 400 having multiple wires connected to the base disk 200 or a plurality of disks selected from the sub-disks and sequentially disposed in the arrangement direction or disposed to partially face each other in the circumferential direction of the sub-disks; and a wire operator 500 operating the wires to rotate the sub-disks by a predetermined angle.

The base disk 200 disposed at a predetermined distance forward from the front surface of a frame 201 by spacing rods 202. The spacing rods 202 extend in the front-rear direction and have a rear end fixed to the front surface of the frame 201 and a front end fixed to the rear surface of the base disk 200. The base disk 200 described above is formed in an octagonal plate shape having a predetermined thickness, but is not limited thereto and may be formed in various shapes such as a circle. Further, multiple first fixing pulleys 203 for installing wires are disposed on the front surface of the base disk 200. In the example shown in the figures, eight first fixing pulley 203 are disposed radially with the intervals of 45 degrees on the base disk 200, but the number of the first fixing pulleys 203 that are installed is not limited thereto and the first fixing pulleys 203 may be variously provided, depending on the number of sub-disks of the rotary unit or the number of wires. In this configuration, it is preferable that the first fixing pulleys 203 are radially disposed around the center of the base disk 200 in accordance with the arrangement type of wires.

In this configuration, the frame 201 includes a front plate 211 and a rear plate 212 spaced apart from each other, and multiple supporting rods 213 fixed at both ends to the front plate 211 and the rear plate 212, respectively. The base disk is installed on the front surface of the front plate 211 by the spacing rods. The supporting rods 213 extend in the front-rear direction and have front and rear ends fixed to the front plate 211 and the rear plate 212, respectively, thereby supporting the front plate 211 and the rear plate 212 with a gap therebetween.

The rotary unit 300 includes multiple odd sub-disks 310 and even sub-disks 320 rotatably connected to each other by rotary joints 330, and the odd sub-disks 310 and even sub-disks 320 are alternately arranged in the arrangement direction, that is, in the front-rear direction. In this configuration, a quaternion joint is applied as the rotary joint 330. The quaternion joint is formed to be able to bend in various directions and a quaternion joint that is generally used in the related art is applied, so detailed description is omitted.

The odd sub-disks 310 are formed to have an octagonal cross-section to correspond to the base disk 200. The odd sub-disk 310 that is the most adjacent to the base disk 200 of the odd sub-disks 310 at the connector, that is, the rearmost odd sub-disk 310 is rotatably connected to the base disk 200 by a corresponding rotary joint 330. Further, multiple second fixing pulleys 311 for installing wires are disposed on the front surface of the odd sub-disk 310. The multiple second fixing pulleys 311 are radially disposed around the center of the odd sub-disk 310. Meanwhile, four second fixing pulleys 311 are installed on the odd sub-disk 310 in the example shown in the figures, but the present disclosure is not limited thereto and multiple second fixing pulleys may be provided, depending on the number of wires.

The even sub-disks 320 are formed to have an octagonal cross-section to correspond to the odd sub-disks 310. Further, multiple second fixing pulleys 321 for installing wires are disposed on the front surface of the even sub-disk 320. Meanwhile, a structure in which four third fixing pulleys 321 are installed on the even sub-disk 320 is shown in the example shown in the figures, but the present disclosure is not limited thereto and multiple third fixing pulleys may be provided, depending on the number of wires. The even sub-disk 320 is rotatably installed between the odd sub-disks 310 using the rotary joint 330. Both ends of the rotary joint 330 are installed at the center portion of the odd sub-disk 310 and at the center portion of the even sub-disk 320, respectively.

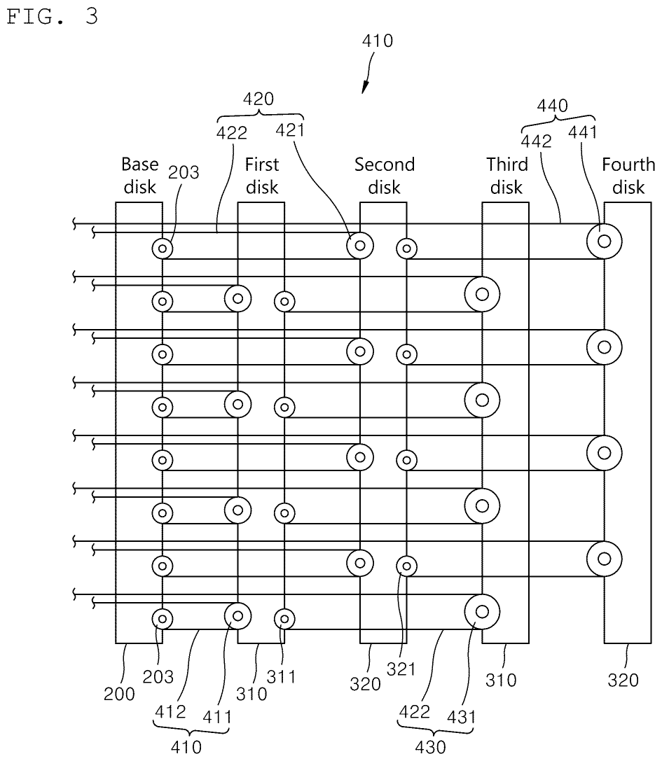

The odd sub-disks 310 and the even sub-disks 320 configured as described above are alternately arranged in the front-rear direction. In FIG. 3, ‘First disk’ and ‘Third disk’ indicate the odd sub-disks 310, and ‘Second disk’ and ‘Fourth disk’ indicate the even sub-disks 320.

Meanwhile, a structure in which the rotary unit 300 includes two odd sub-disks (‘First disk’ and ‘Third disk’) 310 and two even sub-disks (‘Second disk’ and ‘Fourth disk’) 320 is shown in the example shown in FIG. 3, but the rotary unit 300 is not limited thereto and may include three or more odd sub-disks 310 and even sub-disks 320, depending on the size, the purpose, or the like of the robot arm that is manufactured.

The wire connector 400 includes a first main connecting unit 410 connecting the base disk 200 and the odd sub-disk 310, a second main connecting unit 420 connecting the base disk 200 and the even sub-disk 320, a first sub-connecting unit 430 connecting odd sub-disks 310 adjacent to each other, and a second sub-connecting unit 440 connecting even sub-disks 320 adjacent to each other.

The first main connecting unit 410 includes a first main pulley 411 rotatably installed on the odd sub-disk 310 that is the most adjacent to the base disk 200 of the odd sub-disks 310, and multiple first main wires 412 installed on the base disk 200, wound on the first main pulley 411, and having an end connected to the wire operator 500.

The first main pulley 411 is rotatably installed on the rear surface of the odd sub-disk 310 that is the most adjacent to the base disk 200 of the odd sub-disks 310, that is, the rearmost odd sub-disk (‘First disk’) 310. Multiple first main pulleys 411 are radially arranged around the center of the rearmost odd sub-disk. Further, it is preferable that four first main pulleys 411 are disposed with radial angles of 90 degrees and are installed on the rear surface of the rearmost odd sub-disk at positions facing the first fixing pulleys 203 of the base disk 200.

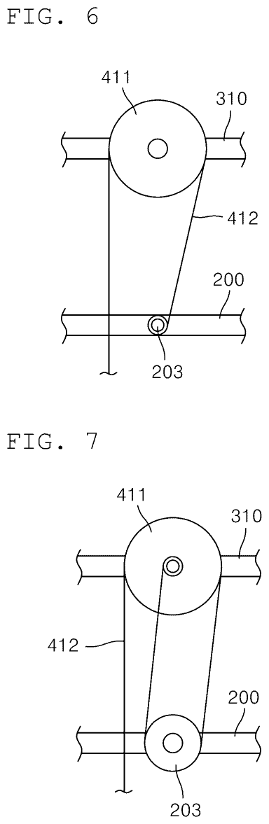

Referring to FIG. 6, the first main wire 412 is installed to be wound on the outer circumferential surface of the first main pulley 411 such that a first end is fixed to the first fixing pulley 203 of the base disk 200 that faces the first main pulley 411. In this configuration, a second end of the first main wire 412, though not shown in the figures, is connected to the wire operator 500 through the base disk 200. Four first main wires 412 are radially disposed around the center of the rearmost odd sub-disk 310 and are disposed in pairs facing each other with the center of the rearmost odd sub-disk 310 therebetween.

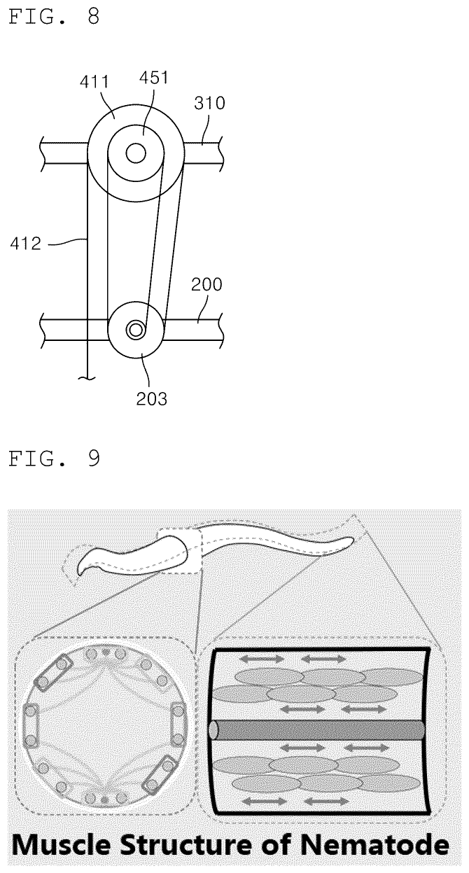

Meanwhile, the first main connecting unit 410 is not limited thereto and may be configured, as shown in FIG. 7. Referring to FIG. 7, the first main connecting unit 410 may be configured such that the first fixing pulley 203 is rotatably installed on the base disk 200, a first end of the first main wire 412 is fixed to the rotary shaft of the first main pulley 411, the first main wire 412 is wound on the outer circumferential surface of the first fixing pulley 203 and then wound on the outer circumferential surface of the first main pulley 411, and a second end thereof is connected to the wire operator 500 through the base disk 200.

Further, the first main connecting unit 410, as shown in FIG. 8, may include an assistant pulley 451 rotatably installed on the rotary shaft of the first main pulley 411. Referring to FIG. 8, a first end of the first main wire 412 may be fixed to the rotary shaft of the first fixing pulley 203, the first main wire 412 may be wound on the outer circumferential surface of the assistant pulley 451 and then wound on the outer circumferential surface of the first fixing pulley 203, and a second end thereof may be wound on the outer circumferential surface of the first main pulley 411 and then connected to the wire operator 500 through the base disk 200.

As described above, since the first main connecting unit 410 supports the first main wire 412 using multiple pulleys, it is possible to reduce external force required to rotate the odd sub-disk 410, so it is possible to increase the payload of the robot arm.

The second main connecting unit 420 includes a second main pulley 421 rotatably installed on the even sub-disk 320 that is the most adjacent to the base disk 200 of the even sub-disks 320, and multiple second main wires 422 installed on the base disk 200, wound on the second main pulley 421, and having an end connected to the wire operator 500.

The second main pulley 421 is rotatably installed on the rear surface of the even sub-disk 320 that is the most adjacent to the base disk 200 of the even sub-disks 320, that is, the rearmost even sub-disk (‘First disk’) 320. Multiple second main pulleys 421 are radially arranged around the center of the rearmost even sub-disk 320. In this configuration, it is preferable that four second main pulleys 421 are disposed with radial angles of 90 degrees and are installed on the rear surface of the rearmost even sub-disk 320 at positions facing the first fixing pulleys 203 on which the first main wire 412 is not installed.

The second main wire 422 is installed such that a first end is fixed to the first fixing pulley 203, on which the first main wire 412 is not installed, and is wound on the second main pulley 421 through the rearmost odd sub-disk 310. In this configuration, a second end of the second main wire 422 is connected to the wire operator 500 through the rearmost odd sub-disk 310 and the base disk 200. Four first main wires 422 are radially disposed around the center of the rearmost even sub-disk 320 and are disposed in pairs facing each other with the center of the rearmost even sub-disk 320 therebetween.

In this configuration, it is preferable that the first main wire 412 and the second main wire 422 are radially disposed around from the center of the base disk 200 and are alternately arranged in the circumferential direction of the base disk 200. Meanwhile, the second main connecting unit 420 may be configured as shown in FIG. 7 and FIG. 8.

The first sub-connecting unit 430 includes multiple first sub-pulleys 431 rotatably installed on any one of the odd sub-disks 310 adjacent to each other, and multiple first sub-wires 432 installed on another one of the odd sub-disks 310 adjacent to each other, wound on the first sub-pulley 431, and having an end connected to the wire operator 500.

The first sub-pulley 431 is rotatably installed on the rear surface of any one of odd sub-disks 310 adjacent to each other, that is, a front odd sub-disk (‘Third disk’) 310. Multiple first sub-pulleys 431 are radially arranged around the center of the front odd sub-disk 310. In this configuration, it is preferable that four first sub-pulleys 431 are disposed with radial angles of 90 degrees, face to the first main pulleys 411, respectively, and are disposed at positions spaced apart from each other in the front-rear direction.

The first sub-wire 432 is installed to be fixed to the second fixing pulley 311 of another one of the odd sub-disks 310 adjacent to each other, that is, a rear odd sub-disk (′First disk) 310, and to be wound on the first sub-pulley 431 on the rear surface of the front odd sub-disk 310. The first sub-wire 432 is installed through another odd sub-disk 310, an even sub-disk 320, and the base disk 200, and a second end thereof is connected to the wire operator 500. It is preferable that four first sub-wires 432 are radially arranged around the center of the rear odd sub-disk 310 and are disposed in pairs facing each other with the center of the rear odd sub-disk 310 therebetween. Meanwhile, the first sub-connecting unit 430 may be configured as shown in FIG. 7 and FIG. 8.

Further, it is preferable that the first sub-wire 432 installed on the odd sub-disk (‘First disk’) 310 that is the most adjacent to the base disk 200 of the first sub-sires 432 is installed between the second main wires 422. Further, the first sub-wire 432 installed on the odd sub-disk (‘First disk’) 310 that is the most adjacent to the base disk 200 of the first sub-sires 432 may be disposed to face the first main wire 412 in the arrangement direction of the disks, that is, the front-rear direction.

The second sub-connecting unit 440 includes multiple second sub-pulleys 441 rotatably installed on any one of the even sub-disks 320 adjacent to each other, and multiple second sub-wires 442 installed on another one of the even sub-disks 320 adjacent to each other, wound on the second sub-pulley 441, and having an end connected to the wire operator 500.

The second sub-pulley 441 is rotatably installed on the rear surface of any one of the even sub-disks 320 adjacent to each other, that is, a rear even sub-disk (‘Fourth disk’) 320. Multiple second sub-pulleys 441 are radially arranged around the center of the front even sub-disk 320. In this configuration, it is preferable that four second sub-pulleys 441 are disposed with radial angles of 90 degrees, face to the second main pulleys 421, respectively, and are disposed at positions spaced apart from each other in the front-rear direction.

The second sub-wire 442 is installed to be fixed to the third fixing pulley 321 of another one of the even sub-disks 320 adjacent to each other, that is, a rear even sub-disk (′Second disk) 320, and to be wound on the second sub-pulley 441 on the rear surface of the front even sub-disk 320. The second sub-wire 442 is installed through another even sub-disk 320, an odd sub-disk 310, and the base disk 200, and a second end thereof is connected to the wire operator 500. It is preferable that four second sub-wires 442 are radially arranged around the center of the rear even sub-disk 320 and are disposed in pairs facing each other with the center of the rear odd sub-disk 310 therebetween. Meanwhile, the second sub-connecting unit 440 may be configured as shown in FIG. 7 and FIG. 8.

In this configuration, the second sub-wires 442 are radially arranged around the center of the even sub-disk 320 and are disposed between the first sub-wires 432 adjacent to each other. Further, it is preferable that the second sub-wire 442 installed on the even sub-disk (‘Second disk’) 320 that is the most adjacent to the base disk 200 of the second sub-sires 442 is disposed to face the second main wire 422 in the arrangement direction of the disks, that is, the front-rear direction.

Since, in the wire connector 400 configured as described above, the first and second main wires 422 and the first and second sub-wires 442 are arranged in the circumferential direction of disks and are disposed between other wires, this configuration is made in a type similar to the muscle structure of a nematode shown in FIG. 9, whereby the rigidity and the payload of the robot arm are increased.

Meanwhile, the wire operator 500 includes a first main rotary unit 510 pulling or releasing the first main wires 412 facing each other with the center of the base disk 200 therebetween, a second main rotary unit pulling or releasing the second main wires 422 facing each other with the center of the base disk 200 therebetween, a first sub-rotary unit pulling or releasing the first sub-sires 432 facing each other with the center of the base disk 200 therebetween, and a second sub-rotary unit pulling or releasing the second sub-sires 442 facing each other with the center of the base disk 200 therebetween.

The first main rotary unit 510 includes a first moving block 511 slidably installed on the frame 201, a plurality of first supporting rollers 512 installed on the first moving block 511 to wire the first main wires 412 thereon, multiple first guide rollers 513 installed on the frame 201 to guide the first main wires 421 such that the first main wires 412 are wound on the first supporting rollers 512, and a first block moving member 514 moving the first moving block 511.

In this configuration, the frame 201 has first wire fixing portions 214 formed at positions spaced part from each other such that the second ends of the first main wires 412 facing each other with the center of the base disk 200 therebetween can be installed.

The first wire fixing portions 214 are installed on the front plate 211 and the rear plate 212 of the frame 201, respectively. It is preferable that the first wire fixing portions 214 are installed at positions facing each other in the front-rear direction. Meanwhile, though not shown in the figures, wire holders that are generally used to fix the second ends of the first main wires 412 in the related art are applied as the first wire fixing portions 214, so detailed description is omitted.

One of the first main wires 412 facing each other with the center of the base disk 200 therebetween passes through the front plate 211 and is then supported by the first supporting roller 512 and the second end thereof is fixed to the first wire fixing portion 214 disposed on the front plate 211.

In this configuration, the other one of the first main wires 412 facing each other with the center of the base disk 200 therebetween passes through the front plate 211 and the rear plate 212, passes through the rear plate 212 again, and is then supported by the first supporting roller 512 and fixed to the first wire fixing portion 214 disposed on the rear plate 212.

Meanwhile, the first moving block 511 is installed to be adjacent to any one of the first wire fixing portions 214 on the frame 201 between the first wire fixing portions 214 and to be able to slide away from the other one of the first wire fixing portions 214. That is, the first moving block 511 is supported by the first block moving member 514 to be slidable in the front-rear direction between the front plate 211 and the rear plate 212. It is preferable that the first moving block 511 is positioned between the first wire fixing portions 214.

The first supporting rollers 512 are installed at the first moving block 511 such that the first main wires 412 facing each other with the center of the base disk 200 therebetween are wound on the outer circumferential surfaces thereof. It is preferable that the first supporting rollers 512 are rotatably installed at the first moving block 511 at positions spaced apart from each other in the front-rear direction. In this configuration, one of the first main wires 412 facing each other with the center of the base disk 200 therebetween is supported by the forward first supporting roller 512 of the first supporting rollers 512 and the other one of the first main wires 412 facing each other with the center of the base disk 200 therebetween is supported by the rear first supporting roller 512 of the first supporting rollers 512.

The first guide rollers 512 are installed on the frame 201 to guide the first main wires 412 facing each other with the center of the base disk 200 therebetween to be wound on the first supporting rollers 512, respectively. The first guide rollers 513 are rotatably installed on the front plate 211 and the rear plate 212 and support the first main wires 412.

The first block moving member 514 moves the first moving block 511 such that pulling force is applied to any one of the first main wires 412 facing each other with the center of the base disk 200 therebetween and pulling force is not applied to the other one of the first main wires 412. In this configuration, the first block moving member 514 is installed on the front plate 211 and the rear plate 212 and moves the first moving block 511 in the front-rear direction. An actuator that can move the first moving block 511 in the front-rear direction such as a ball screw, a screw jack, and a hydraulic cylinder is applied as the first block moving member 514.

When the first moving block 511 is moved forward toward the front plate 211 by the first block moving member 514, the first main wire 412 installed at the first wire fixing portion 214 of the rear plate 212 is pulled and the first main wire 412 installed at the first wire fixing portion 214 of the front plate 211 is released. On the other hand, when the first moving block 511 is moved rearward toward the rear plate 212 by the first block moving member 514, the first main wire 412 installed at the first wire fixing portion 214 of the front plate 211 is pulled and the first main wire 412 installed at the first wire fixing portion 214 of the rear plate 212 is released. A worker can rotate the odd sub-disk 310 with respect to the base disk 200 by pulling or releasing the first main wires 412 by operating the first block moving member 514.

Meanwhile, the first main rotary unit 510 is not limited thereto and any wire operating mechanism can be applied as long as it can pull or release the first main wires 412 facing each other with the base disk 200 therebetween.

The second main rotary unit, though not shown in the figures, includes a second moving block slidably installed on the frame 201, a plurality of second supporting rollers installed on the second moving block to wind the second main wires 422 thereon, multiple second guide rollers installed on the frame 201 to guide the second main wires 422 such that the second main wires 422 are wound on the second supporting rollers, and a second block moving member moving the second moving block.

In this configuration, the frame 201, though not shown in the figures, has second wire fixing portions formed at positions spaced part from each other such that the second ends of the second main wires 422 facing each other with the center of the base disk 200 therebetween can be installed.

The second wire fixing portions are installed on the front plate 211 and the rear plate 212 of the frame 201, respectively. It is preferable that the second wire fixing portions are installed to face each other in the front-rear direction. In this configuration, the second wire fixing portions are installed on the frame 201 at positions spaced apart from the first wire fixing portions 214. Meanwhile, though not shown in the figures, wire holders that are generally used to fix the second ends of the second main wires 422 in the related art are applied as the second wire fixing portions, so detailed description is omitted.

One of the second main wires 422 facing each other with the center of the base disk 200 therebetween passes through the front plate 211 and is then supported by the second supporting roller and the second end thereof is fixed to the second wire fixing portion disposed on the front plate 211.

In this configuration, the other one of the second main wires 422 facing each other with the center of the base disk 200 therebetween passes through the front plate 211 and the rear plate 212, passes through the rear plate 212 again, and is then supported by the second supporting roller and fixed to the second wire fixing portion disposed on the rear plate 212.

Meanwhile, the second moving block is installed to be adjacent to any one of the second wire fixing portions on the frame 201 between the second wire fixing portions and to be able to slide away from the other one of the second wire fixing portions. That is, though not shown in the figures, the second moving block is supported by the second block moving member to be slidable in the front-rear direction between the front plate 211 and the rear plate 212. It is preferable that the second moving block is positioned between the second wire fixing portions.

The second supporting rollers are installed at the second moving block such that the second main wires 422 facing each other with the center of the base disk 200 therebetween are wound on the outer circumferential surfaces thereof. It is preferable that the second supporting rollers are rotatably installed at the second moving block at positions spaced apart from each other in the front-rear direction. One of the second main wires 422 facing each other with the center of the base disk 200 therebetween is supported by the forward second supporting roller of the second supporting rollers, and the other one of the second main wires 422 facing each other with the center of the base disk 200 therebetween is supported by the rear second supporting roller of the second supporting rollers.

The second guide rollers are installed on the frame 201 to guide the second main wires 422 facing each other with the center of the base disk 200 therebetween to be wound on the second supporting rollers, respectively. The second guide rollers are rotatably installed on the front plate 211 and the rear plate 212 and support the second main wires 422.

The second block moving member 514 moves the second moving block such that pulling force is applied to any one of the second main wires 422 facing each other with the center of the base disk 200 therebetween and pulling force is not applied to the other one of the second main wires 422. In this configuration, the second block moving member is installed on the front plate 211 and the rear plate 212 and moves the second moving block in the front-rear direction. An actuator that can move the second moving block in the front-rear direction such as a ball screw, a screw jack, and a hydraulic cylinder is applied as the second block moving member. It is preferable that the second main rotary unit configured as describe above has the same structure as the first main rotary unit 510 shown in FIG. 4.

When the second moving block is moved forward toward the front plate 211 by the second block moving member, the second main wire 422 installed at the second wire fixing portion of the rear plate 212 is pulled and the second main wire 422 installed at the second wire fixing portion of the front plate 211 is released. On the other hand, when the second moving block is moved rearward toward the rear plate 212 by the second block moving member, the second main wire 422 installed at the second wire fixing portion of the front plate 211 is pulled and the second main wire 422 installed at the second wire fixing portion of the rear plate 212 is released. A worker can rotate the even sub-disk 320 with respect to the base disk 200 by pulling or releasing the second main wires 422 by operating the second block moving member.

Meanwhile, the second main rotary unit is not limited thereto and any wire operating mechanism can be applied as long as it can pull or release the second main wires 422 facing each other with the base disk 200 therebetween.

The first sub-rotary unit, though not shown in the figures, includes a third moving block slidably installed on the frame 201, a plurality of third supporting rollers installed on the third moving block to wind the first sub-wires 432 thereon, multiple third guide rollers installed on the frame 201 to guide the first sub-wires 432 such that the first sub-wires 432 are wound on the third supporting rollers, and a third block moving member moving the third moving block.

In this configuration, the frame 201, though not shown in the figures, has third wire fixing portions formed at positions spaced part from each other such that the second ends of the first sub-wires 432 facing each other with the center of the base disk 200 therebetween can be installed.

The third wire fixing portions are installed on the front plate 211 and the rear plate 212 of the frame 201, respectively. It is preferable that the third wire fixing portions are installed to face each other in the front-rear direction. In this configuration, the third wire fixing portions are installed on the frame 201 at positions spaced apart from the first wire fixing portions 214 and the second wire fixing portions. Meanwhile, though not shown in the figures, wire holders that are generally used to fix the second ends of the first sub-wires 432 in the related art are applied as the third wire fixing portions, so detailed description is omitted.

One of the first sub-wires 432 facing each other with the center of the base disk 200 therebetween passes through the front plate 211 and is then supported by the third supporting roller and the second end thereof is fixed to the third wire fixing portion disposed on the front plate 211.

In this configuration, the other one of the first sub-wires 432 facing each other with the center of the base disk 200 therebetween passes through the front plate 211 and the rear plate 212, passes through the rear plate 212 again, and is then supported by the third supporting roller and fixed to the third wire fixing portion disposed on the rear plate 212.

Meanwhile, the third moving block is installed to be adjacent to any one of the third wire fixing portions on the frame 201 between the third wire fixing portions and to be able to slide away from the other one of the third wire fixing portions. That is, though not shown in the figures, the third moving block is supported by the third block moving member to be slidable in the front-rear direction between the front plate 211 and the rear plate 212. It is preferable that the third moving block is positioned between the third wire fixing portions.

The third supporting rollers are installed at the third moving block such that the first sub-wires 432 facing each other with the center of the base disk 200 therebetween are wound on the outer circumferential surfaces thereof. It is preferable that the third supporting rollers are rotatably installed at the third moving block at positions spaced apart from each other in the front-rear direction. One of the first sub-wires 432 facing each other with the center of the base disk 200 therebetween is supported by the forward third supporting roller of the third supporting rollers, and the other one of the first sub-wires 432 facing each other with the center of the base disk 200 therebetween is supported by the rear third supporting roller of the third supporting rollers.

The third guide rollers are installed on the frame 201 to guide the first sub-wires 432 facing each other with the center of the base disk 200 therebetween to be wound on the third supporting rollers, respectively. The third guide rollers are rotatably installed on the front plate 211 and the rear plate 212 and support the first sub-wires 432.

The third block moving member moves the third moving block such that pulling force is applied to any one of the first sub-wires 432 facing each other with the center of the base disk 200 therebetween and pulling force is not applied to the other one of the first sub-wires 432. In this configuration, the third block moving member is installed on the front plate 211 and the rear plate 212 and moves the third moving block in the front-rear direction. An actuator that can move the third moving block in the front-rear direction such as a ball screw, a screw jack, and a hydraulic cylinder is applied as the third block moving member. It is preferable that the first sub-rotary unit configured as describe above has the same structure as the first main rotary unit 510 shown in FIG. 4.

When the third moving block is moved forward toward the front plate 211 by the third block moving member, the first sub-wire 432 installed at the third wire fixing portion of the rear plate 212 is pulled and the first sub-wire 432 installed at the third wire fixing portion of the front plate 211 is released. On the other hand, when the third moving block is moved rearward toward the rear plate 212 by the third block moving member, the first sub-wire 432 installed at the third wire fixing portion of the front plate 211 is pulled and the first sub-wire 432 installed at the third wire fixing portion of the rear plate 212 is released. A worker rotates the odd sub-disks 310 with respect to each other by puling or releasing the first sub-wires 432 by operating the third block moving member.

Meanwhile, the first sub-rotary unit is not limited thereto and any wire operating mechanism can be applied as long as it can pull or release the first sub-wires 432 facing each other with the base disk 200 therebetween.

The second sub-rotary unit, though not shown in the figures, includes a fourth moving block slidably installed on the frame 201, a plurality of fourth supporting rollers installed on the fourth moving block to wind the second sub-wires 442 thereon, multiple fourth guide rollers installed on the frame 201 to guide the second sub-wires 442 such that the second sub-wires 442 are wound on the fourth supporting rollers, and a fourth block moving member moving the fourth moving block.

The frame 201, though not shown in the figures, has fourth wire fixing portions formed at positions spaced part from each other such that the second ends of the second sub-wires 442 facing each other with the center of the base disk 200 therebetween can be installed.

The fourth wire fixing portions are installed on the front plate 211 and the rear plate 212 of the frame 201, respectively. It is preferable that the fourth wire fixing portions are installed to face each other in the front-rear direction. In this configuration, the fourth wire fixing portions are installed on the frame 201 at positions spaced apart from the first to third wire fixing portions. Meanwhile, though not shown in the figures, wire holders that are generally used to fix the second ends of the second sub-wires 432 in the related art are applied as the fourth wire fixing portions, so detailed description is omitted.

One of the second sub-wires 442 facing each other with the center of the base disk 200 therebetween passes through the front plate 211 and is then supported by the fourth supporting roller and the second end thereof is fixed to the fourth wire fixing portion disposed on the front plate 211.

In this configuration, the other one of the second sub-wires 442 facing each other with the center of the base disk 200 therebetween passes through the front plate 211 and the rear plate 212, passes through the rear plate 212 again, and is then supported by the fourth supporting roller and fixed to the fourth wire fixing portion disposed on the rear plate 212.

Meanwhile, the fourth moving block is installed to be adjacent to any one of the fourth wire fixing portions on the frame 201 between the fourth wire fixing portions and to be able to slide away from the other one of the fourth wire fixing portions. That is, though not shown in the figures, the fourth moving block is supported by the fourth block moving member to be slidable in the front-rear direction between the front plate 211 and the rear plate 212. It is preferable that the fourth moving block is positioned between the fourth wire fixing portions.

The fourth supporting rollers are installed at the fourth moving block such that the second sub-wires 442 facing each other with the center of the base disk 200 therebetween are wound on the outer circumferential surfaces thereof. It is preferable that the fourth supporting rollers are rotatably installed at the fourth moving block at positions spaced apart from each other in the front-rear direction. One of the second sub-wires 442 facing each other with the center of the base disk 200 therebetween is supported by the forward fourth supporting roller of the fourth supporting rollers, and the other one of the second sub-wires 442 facing each other with the center of the base disk 200 therebetween is supported by the rear fourth supporting roller of the fourth supporting rollers.

The fourth guide rollers are installed on the frame 201 to guide the second sub-wires 442 facing each other with the center of the base disk 200 therebetween to be wound on the fourth supporting rollers, respectively. The fourth guide rollers are rotatably installed on the front plate 211 and the rear plate 212 and support the second sub-wires 442.

The fourth block moving member moves the fourth moving block such that pulling force is applied to any one of the second sub-wires 442 facing each other with the center of the base disk 200 therebetween and pulling force is not applied to the other one of the second sub-wires 442. An actuator that can move the fourth moving block in the front-rear direction such as a ball screw, a screw jack, and a hydraulic cylinder is applied as the fourth block moving member. It is preferable that the second sub-rotary unit configured as describe above has the same structure as the first main rotary unit 510 shown in FIG. 4.

When the fourth moving block is moved forward toward the front plate 211 by the fourth block moving member, the second sub-wire 442 installed at the fourth wire fixing portion of the rear plate 212 is pulled and the second sub-wire 442 installed at the fourth wire fixing portion of the front plate 211 is released. On the other hand, when the fourth moving block is moved rearward toward the rear plate 212 by the fourth block moving member, the second sub-wire 442 installed at the fourth wire fixing portion of the front plate 211 is pulled and the second sub-wire 442 installed at the fourth wire fixing portion of the rear plate 212 is released. A worker rotates the even sub-disks 320 with respect to each other by puling or releasing the second sub-wires 442 by operating the fourth block moving member.

Meanwhile, the second sub-rotary unit is not limited thereto and any wire operating mechanism can be applied as long as it can pull or release the second sub-wires 442 facing each other with the base disk 200 therebetween.

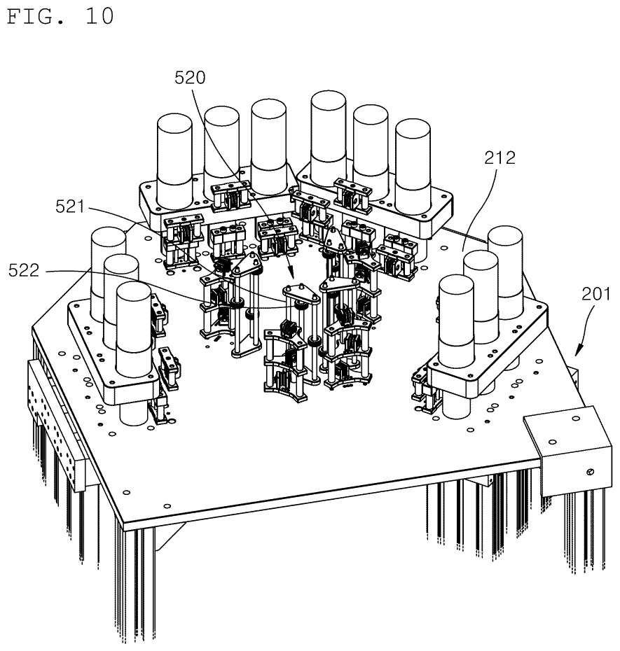

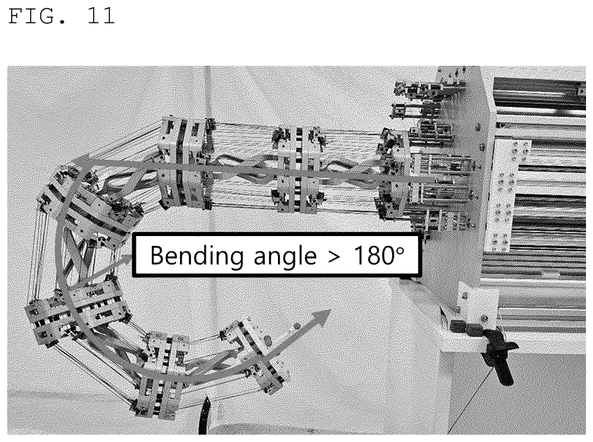

Meanwhile, the wire operator 500, as shown in FIG. 10, may further include an anti-interference unit 520 that guide the first main wires 412, the second main wires 422, the first sub-sires 432, and the second sub-wires 442 to prevent interference between the wires.

The anti-interference unit 520 includes multiple installation rods 521 installed on the rear plate 212 of the frame 201, and multiple prevention rollers 522 rotatably installed on the installation rods 521, respectively, and supporting any one wire of the first main wires 412, the second main wires 422, the first sub-sires 432, and the second sub-wires 442. The installation rods 521 are radially disposed around the center of the rear plate 212. Further, the prevention rollers 522 are installed on the installation rods 521, respectively, at different distances from the rear plate 212, and support the wires. Since the first main wires 412, the second main wires 422, the first sub-sires 432, and the second sub-wires 442 are supported by the prevention rollers 522 described above, it is possible to interference between the wires.

Meanwhile, a performance test was performed on the rigidity and payload of the snake arm robot 100 according to the present disclosure. The following Table 1 shows the result of a performance test on the snake arm robot 100 of the present disclosure.

TABLE 1

| | Length | Rigidity | Payload |
|---|---|---|---|
| | [mm] | [N/mm] | [kg] |
| CDHM | 1500 | — | 2.5 |
| S-CDRSM | 1680 | 0.25~0.35 | 1.5 |
| CSRM | 1265 | 0.657 | 1.5 |
| [symbol] 2 | 1160 | 2.5529 | 5.0 |

In the table, CDHM, S-CDRSM, and CSRM are existing snake arm-type robots and the length is the entire length of each of the robot arms. The test was performed with a length of 1160 mm and a diameter of a disk of 150 mm in the present disclosure. Referring to Table 1, it can be seen that the snake arm robot 100 of the present disclosure has higher rigidity and payload than the existing robot arms. Meanwhile, a performance test result on a bending angle of the snake arm robot 100 of the present disclosure is shown in FIG. 11. Referring to the figure, it can be seen that the bending angle of the snake arm robot 100 of the present disclosure is excellent as over 180 degrees.

Since wires connected to disks to rotate the disks are arranged in a similar type to the muscle structure of a nematode in the snake arm robot 100 configured as described above in accordance with the present disclosure, there is the advantage that rigidity and payload are increased.

The description of the proposed embodiments is provided to enable those skilled in the art to use or achieve the present disclosure. Various modifications of the embodiments would be apparent to those skilled in the art, and general principles defined herein may be applied to other embodiments without departing from the scope of the present disclosure. Therefore, the present disclosure is not limited to the embodiments proposed herein and should be construed in the widest range that is consistent with the principles proposed herein and new characteristics.

What is claimed is:

1. A snake arm robot comprising:
a base disk;
a rotary unit rotatably connected to the base disk and having multiple sub-disks sequentially arranged in a predetermined arrangement direction and rotatably connected to each other;
a wire connector having multiple wires connected to the base disk or a plurality of disks selected from the sub-disks and sequentially disposed in the arrangement direction or disposed to partially face each other in a circumferential direction of the sub-disks; and
a wire operator operating the wires to rotate the sub-disks by a predetermined angle.

2. The snake arm robot of claim 1, wherein the wires are radially disposed around a center of the base disk or the sub-disks.

3. The snake arm robot of claim 2, wherein the rotary unit includes multiple odd sub-disks and even sub-disks rotatably connected to each other by rotary joints, and the odd sub-disks and even sub-disks are alternately arranged in the arrangement direction, and
the wires are connected to the odd sub-disks adjacent to each other or the even sub-disks adjacent to each other, respectively.

4. The snake arm robot of claim 3, wherein the wire connector includes:
a first sub-connecting unit including multiple first sub-pulleys rotatably installed on any one of the odd sub-disks adjacent to each other, and multiple first sub-wires installed on the other one of the odd sub-disks adjacent to each other, wound on the first sub-pulleys, and having an end connected to the wire operator; and
a second sub-connecting unit including multiple second sub-pulleys rotatably installed on any one of the even sub-disks adjacent to each other, and multiple second sub-wires installed on the other one of the even sub-disks adjacent to each other, wound on the second sub-pulleys, and having an end connected to the wire operator.

5. The snake arm robot of claim 4, wherein the first sub-wires are radially disposed around a center of the odd sub-disk, and
the second sub-wires are radially disposed around a center of the even sub-disk and are disposed between the first sub-wires adjacent to each other.

6. The snake arm robot of claim 4, wherein the wire connector includes:
a first main connecting unit including a first main pulley rotatably installed on an odd sub-disk that is the most adjacent to the base disk of the odd sub-disks, and multiple first main wires installed on the base disk, wound on the first main pulley, and having an end connected to the wire operator; and
a second main connecting unit including a second main pulley rotatably installed on an even sub-disk that is the most adjacent to the base disk of the even sub-disks, and multiple second main wires installed on the base disk, wound on the second main pulley, and having an end connected to the wire operator.

7. The snake arm robot of claim 6, wherein the first main wires and the second main wires are radially disposed around the center of the base disk and are alternately arranged in a circumferential direction of the base disk.

8. The snake arm robot of claim 7, wherein a first sub-wire installed on the odd sub-disk that is the most adjacent to the base disk of the first sub-wires is disposed between the second main wires.

9. The snake arm robot of claim 8, wherein a first sub-wire installed on the odd sub-disk that is the most adjacent to the base disk of the first sub-wires is disposed to face the first main wire in the arrangement direction.

10. The snake arm robot of claim 7, wherein a second sub-wire installed on the even sub-disk that is the most adjacent to the base disk of the second sub-wires is disposed to face the second main wire in the arrangement direction.

11. The snake arm robot of claim 7, wherein the wire operator includes a first main rotary unit pulling or releasing the first main wires facing each other with the center of the base disk therebetween.

12. The snake arm robot of claim 11, wherein first ends of the first main wires facing each other with the center of the base disk therebetween are installed on the base disk or the odd sub-disk,
the frame has first wire fixing portions formed at positions spaced apart from each other such that second ends of the first main wires facing each other with the center of the base disk therebetween can be installed respectively thereto, and
the first main rotary unit includes:
a first moving block installed to be adjacent to any one of the first wire fixing portions on the frame between the first wire fixing portions and to be able to slide away from the other one of the first wire fixing portions;
a plurality of first supporting rollers installed at the first moving block such that the first main wires facing each other with the center of the base disk therebetween are wound on outer circumferential surfaces thereof;
multiple first guide rollers installed on the frame to guide the first main wires facing each other with the center of the base disk therebetween to be wound on the first supporting rollers, respectively; and
a first block moving member moving the first moving block such that pulling force is applied to any one of the first main wires facing each other with the center of the base disk therebetween and pulling force is not applied to the other one of the first main wires.

13. The snake arm robot of claim 7, wherein the wire operator includes a second main rotary unit pulling or releasing the second main wires facing each other with the center of the base disk therebetween.

14. The snake arm robot of claim 13, wherein first ends of the second main wires facing each other with the center of the base disk therebetween are installed on the base disk or the even sub-disk,
the frame has second wire fixing portions formed at positions spaced apart from each other such that second ends of the second main wires facing each other with the center of the base disk therebetween can be installed respectively thereto, and
the second main rotary unit includes:
a second moving block installed to be adjacent to any one of the second wire fixing portions on the frame between the second wire fixing portions and to be able to slide away from the other one of the second wire fixing portions;
a plurality of second supporting rollers installed at the second moving block such that the second main wires facing each other with the center of the base disk therebetween are wound on outer circumferential surfaces thereof;
multiple second guide rollers installed on the frame to guide the second main wires facing each other with the center of the base disk therebetween to be wound on the second supporting rollers, respectively; and
a second block moving member moving the second moving block such that pulling force is applied to any one of the second main wires facing each other with the center of the base disk therebetween and pulling force is not applied to the other one of the second main wires.

15. The snake arm robot of claim 5, wherein the wire operator includes a first sub-rotary unit pulling or releasing the first sub-wires facing each other with the center of the base disk therebetween.

16. The snake arm robot of claim 15, wherein first ends of first sub-wires facing each other with the center of the base disk therebetween are installed on the odd sub-disk,
the frame has third wire fixing portions formed at positions spaced apart from each other such that second ends of the first sub-wires facing each other with the center of the base disk therebetween can be installed respectively thereto, and
the first sub-rotary unit includes:
a third moving block installed to be adjacent to any one of the third wire fixing portions on the frame between the third wire fixing portions and to be able to slide away from the other one of the third wire fixing portions;
a plurality of third supporting rollers installed at the third moving block such that the first sub-wires facing each other with the center of the base disk therebetween are wound on outer circumferential surfaces thereof;
multiple third guide rollers installed on the frame to guide the first sub-wires facing each other with the center of the base disk therebetween to be wound on the third supporting rollers, respectively; and
a third block moving member moving the third moving block such that pulling force is applied to any one of the first sub-wires facing each other with the center of the base disk therebetween and pulling force is not applied to the other one of the first sub-wires.

17. The snake arm robot of claim 5, wherein the wire operator includes a second sub-rotary unit pulling or releasing the second sub-wires facing each other with the center of the base disk therebetween.

18. The snake arm robot of claim 17, wherein first ends of the second sub-wires facing each other with the center of the base disk therebetween are installed on the even sub-disk,
the frame has fourth wire fixing portions formed at positions spaced apart from each other such that second ends of the second sub-wires facing each other with the center of the base disk therebetween can be installed respectively thereto, and
the second sub-rotary unit includes:
a fourth moving block installed to be adjacent to any one of the fourth wire fixing portions on the frame between the fourth wire fixing portions and to be able to slide away from the other one of the fourth wire fixing portions;
a plurality of fourth supporting rollers installed at the fourth moving block such that the second sub-wires facing each other with the center of the base disk therebetween are wound on outer circumferential surfaces thereof;
multiple fourth guide rollers installed on the frame to guide the second sub-wires facing each other with the center of the base disk therebetween to be wound on the fourth supporting rollers, respectively; and
a fourth block moving member moving the fourth moving block such that pulling force is applied to any one of the second sub-wires facing each other with the center of the base disk therebetween and pulling force is not applied to the other one of the second sub-wires.

19. The snake arm robot of claim 3, wherein the rotary joint is a quaternion joint.
